(19) United States
(12) Patent Application Publication
(10) Pub. No.: US 2023/0130351 A1
(43) Pub. Date: Apr. 27, 2023

(54) DIRECT SOLAR ENERGY TO DEVICE TRANSMISSION

(71) Applicant: RL Patents, LLC, San Francisco, CA (US)

(72) Inventor: Ricky Lam, San Francisco, CA (US)

(21) Appl. No.: 17/509,093

(22) Filed: Oct. 25, 2021

(51) Int. Cl. H02J 50/30; H02S 10/40

(52) U.S. Cl. CPC H02J 50/30; H02S 10/40

(57) ABSTRACT

System and method for direct solar energy to device transmission includes collecting and converting solar radiation energy to electrical energy by at least one satellite, generating a transmissive energy from the electrical energy, forming a transmissive energy beam, transmitting the energy beam from space directly to an electronic device located on Earth, receiving the energy beam by the electronic device's rectenna, converting the energy beam to alternating current, matching rectenna's antenna impedance with the rectenna's rectifying circuit impedance, rectifying the alternating current to direct current, and powering a load of the electronic device.

### FIELD OF TECHNOLOGY

This disclosure relates generally to techniques collecting and converting solar energy for direct transmission to electronic devices.

### BACKGROUND

Many electronic devices are powered by batteries. The frequent use of these devices may require a significant amount of power, which may easily deplete the batteries attached to them. Rechargeable batteries are often used to avoid the cost of replacing conventional dry-cell batteries, and to conserve precious resources. Therefore, users are frequently needed to plug in the devices to power sources. This may require having to charge electronic equipments at least once a day—or for high-demand electronic devices—more than once a day. Such an activity may be tedious and may represent a burden to the users. For example, a user may be required to carry chargers in the event their electronic equipment is lacking power. In addition, the user may have to search for available power sources to connect to. Such wired charging mechanisms may limit the movement, and thus the usability, of the device while it is being charged. Additionally, as the number of devices connected to a charging source increases, the amount of wires within its proximity may also increase, causing cord clutter.

Most of the world's power is generated by fossil fuel combustion. In the United States, a majority of greenhouse gas emissions come from the combustion of fossil fuels. Combustion of fossil fuels also produces other air pollutants, such as, e.g., nitrogen oxides, sulfur dioxide, volatile organic compounds and heavy metals. Additionally, the cost of producing energy is high, due in-part to depleting fossil fuel reserves. Clean, renewable energy sources are required to meet upcoming energy demands.

### SUMMARY

System and method for direct solar energy to device transmission includes collecting and converting solar radiation energy to electrical energy by at least one satellite, generating a transmissive energy from the electrical energy, forming a transmissive energy beam, transmitting the energy beam from space directly to an electronic device located on Earth, receiving the energy beam by the electronic device's rectenna, converting the energy beam to alternating current, matching rectenna's antenna impedance with the rectenna's rectifying circuit impedance, rectifying the alternating current to direct current, and powering a load of the electronic device.

The transmissive energy may be microwave energy, radiofrequency energy, and/or laser energy. The satellite includes a solar radiation collection and converting means, such as, e.g., a photovoltaic cell and/or or an optical rectenna configured to collect and convert electromagnetic radiation in the terahertz range, optical range, or both. The optical rectenna includes a nantenna and a rectifier. The nantenna is configured to receive solar radiation and convert it to alternating current. The nantenna may be manufactured by an additive manufacturing process, and comprises a carbon nanotube, graphene, a metal, or any combination thereof. In some cases, the nantenna may include a ground plane, an optical resonance cavity, and an antenna. The rectifier includes a matching circuit and a rectifying circuit. The matching circuit is configured to match the nantenna's impedance with the optical rectenna rectifying circuit's impedance. The rectifying circuit is configured to rectify the alternating current to direct current.

### BRIEF DESCRIPTION OF THE DRAWINGS

Example embodiments are illustrated by way of example and are not limited to the figures of the accompanying drawings, in which, like references indicate similar elements.

FIG. 1 is a schematic diagram of the physical chemistry of uric acid and monosodium urate formation.

FIGS. 2A-E illustrate alternative configurations of example satellites that may be implemented in the present system and method.

FIG. 3 illustrates a communication payload that may be implemented in the present system and method.

FIG. 4 is a box diagram of an example solar energy collection, conversion, transmission, and reception system.

FIGS. 5A-B are example solar radiation energy collectors and converters that may be implemented in the present system and method.

FIG. 6 illustrates main components of a nantenna of an optical rectenna.

FIGS. 7A-N are example configurations of receiving antennas from an optical rectenna fixated onto a solar radiation harvesting satellite.

FIG. 8 illustrates a carbon nanotube rectenna.

FIG. 9 is a box diagram of an example transmissive energy reception, conversion and utilization system, and is a continuation from FIG. 4.

FIG. 10 illustrates other components that can be found in the example electronic device of FIG. 9.

FIG. 11 is a flowchart of a method for solar energy harvesting, conversion and direct transmission to an electronic device.

FIG. 12 is a flowchart of a method for transmissive energy reception, conversion and utilization.

FIG. 13 is a system of a drop-on-demand type additive printer that may be used to implement one or more embodiments of the present invention.

FIG. 14 is a flow diagram of a method of an additive printing process that may be implemented with one or more embodiments of the present invention.

FIG. 15 is a flow diagram of a method for additive manufacturing an optical antenna or nantenna.

### DETAILED DESCRIPTION

Although the present has been described with reference to specific examples, it will be evident that various modifications and changes may be made without departing from the broader spirit and scope of the various examples. The modifications and variations include any relevant combination of the disclosed features. In addition, the components shown in the figures, their connections, couplings, relationships, and their functions, are meant to be exemplary only, and are not meant to limit the examples described herein.

System and method for space-based solar radiation energy collection and conversion for transmission from space directly to electronic devices without a terrestrial receiver or base station for distribution, which effectively eliminates or minimizes the usage of batteries and fossil fuels by substitution with an environmentally-friendly energy resource. This is made possible from the continual improvements in rectenna designs, which can be manufactured small and efficient enough to fit into electronic devices of all sizes. Due to the high altitudes of satellites, energy transmission may direct power more precisely and effectively to the devices. In addition, without the use of a ground receiver or base station for distribution, there may be minimal obstructions and interferences from terrestrial objects, such as, e.g., trees, mountain ranges, and buildings. Electronic devices may include portable devices, such as, e.g., smart phones, tablets, laptops, cameras; non-portable devices, such as, e.g., household appliances, desktop computers, automobiles, maritime vessels, and aircrafts; and implantable medical devices, such as, e.g., pacemakers, insulin pumps, and deep-brain stimulators.

Solar radiation is collected and converted into electrical energy, which is further converted into a transmissive energy, such as, e.g., microwave, radiofrequency (RF) wave and/or laser energy, by one or more satellites, and then transmitted directly to an electronic device located on Earth from space without an intermediary terrestrial distribution center, such as, e.g., a base station. Solar energy collection and conversion may include one or more optical rectennas, microwave or RF rectennas, photovoltaic or solar cells, and/or thermoelectric or thermionic devices located on the satellites. A rectenna is a receiving antenna that radiates at a predetermined frequency range comprising a rectifier that converts incoming electromagnetic energy into electricity, such as, e.g., direct current. For example, one or more optical antennas or nantennas of a rectenna, such as, e.g., an array, may harvest the solar energy, such as, e.g., in the terahertz (THz) or one of the optical regions of the electromagnetic spectrum, and then convert it to electrical energy by rectifiers of the rectenna. The wireless power transmission application may include a microwave or RF transmitter and/or a laser emitter that is configured to directionally beam towards a microwave or RF rectenna that is embedded within, or otherwise integrated with, the electronic device. For example, the rectenna may be integrated on the covering or “skin” of the device. An antenna of the microwave or RF rectenna collects the transmitted microwave, RF, and/or laser, and converts it into electrical energy by the microwave or RF rectenna's rectifier. This converted energy may be used to power the electronic device and/or to charge an energy reserve, such as, e.g., a battery.

Space-based solar power (SBSP) harvesting differs from ground-based systems and methods in that the means used to collect energy resides on one or more orbiting satellites instead of the earth's surface. Basing such in space results in a higher collection rate of solar energy due to the lack of a diffusing atmosphere. In a conventional ground-based system, a large percentage of the solar energy is lost on its way through the atmosphere by the effects of reflection and absorption. SBSP systems and methods may convert solar energy to a far-field emission, such as, e.g., a microwaves or radio wave and/or laser, outside of the atmosphere which effectively avoids these losses. In addition, there may be a longer collection period and the ability to collect solar energy continuously without the downtime that results from the earth's rotation away from the sun. Use of radiation energy from the sun is an effective and efficient manner that offers the possibility of providing electrical power without the problems of pollution control and waste disposal.

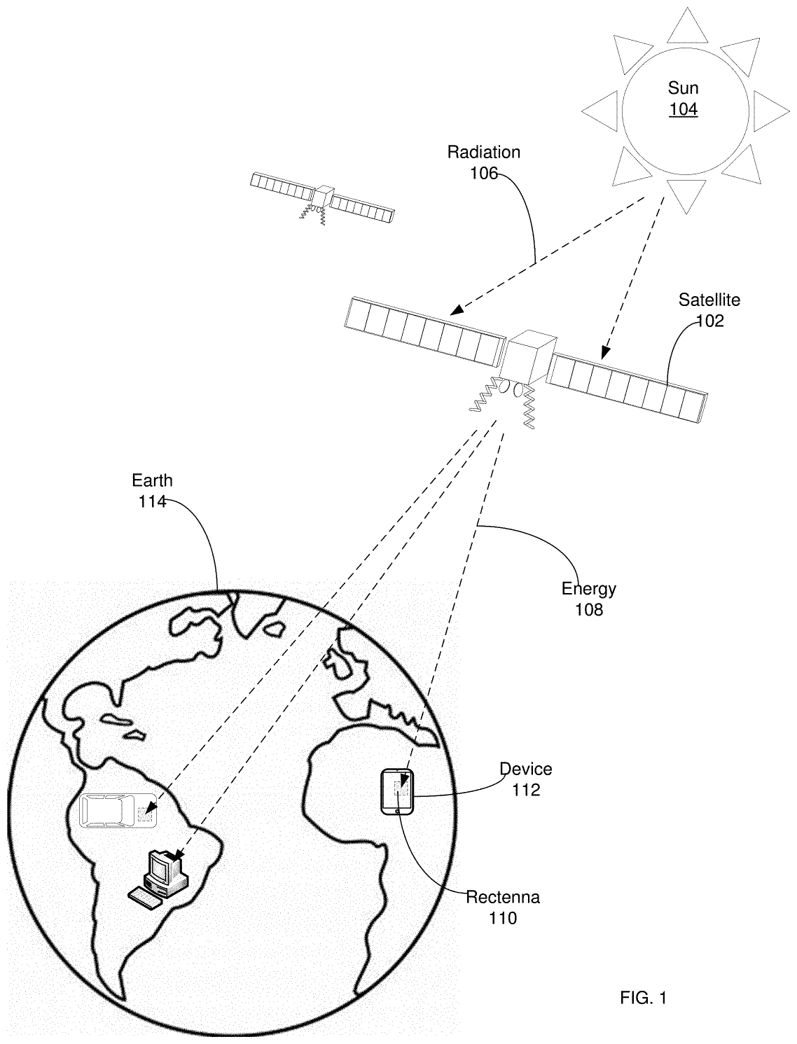

FIG. 1 is a satellite system for harvesting solar energy to be transmitted directly to electronic devices from space. The system may comprise one or more satellite 102 positioned in energy receiving relationship to Sun 104 and having means to collect and convert solar radiation 106 to electrical energy. Satellite 102 may be configured to further convert the electrical energy to transmissive energy 108, such as, e.g., microwave, RF and/or laser energy, and may comprise means to transmit energy 108 to one or more rectenna 110 embedded within, or otherwise integrated with, electronic device 112. For example, the rectenna may be integrated on the covering or “skin” of the device. Rectenna 110 may be configured to convert energy 108 to electrical power in order to operate device 112, or charge a battery of device 112.

A plurality of satellite 102 may be disposed in space, such as, e.g., in a geosynchronous orbit to Earth 114, such that at least one is illuminated by Sun 104 at all times. As an example, at an altitude of approximately 22,300 miles, a satellite 102 moving east to west would be stationary with respect to any point on Earth 114. At times the satellite 102 would pass through Earth 114's shadow. Thus having a plurality of satellite 102 in the same orbit but out of phase permits at least one to be illuminated while the other is in shadow. Such a phase difference may keep the plurality of satellite 102 above the horizon and in direct line of sight to the same point on Earth 114. Alternatively, or in addition, the plurality of satellite 102 may be configured in a low earth orbit to Earth 114. A network of satellite 102 may be employed to achieve the most effective system operation, and to supply transmissive energy 108 to widely dispersed points on Earth 114, either continuously or as required to meet peak power demands.

In addition, a second network of satellite 102 may be disposed between the first network of satellite 102 and the receiving electronic device 112 located on Earth 114, such that the first network collects solar energy and converts it to electrical energy before further converting the electrical energy to transmissive energy 108, then transmits energy 108 to the intermediary second network. The second network may collect energy 108 from the first network prior to distribution directly into user devices from space without a terrestrial distribution center or base station. The collected energy 108 from the second network may be converted to electrical energy, e.g., direct current, prior to reconverting back to energy 108 prior to distribution to user device 112. In addition, or alternatively, one or more satellite 102 of the second network comprises a reflector unit that reflects energy 108 from the first network directly to device 112 rather than collecting energy 108 from the first network, converting to electrical energy, reconverting back to energy 108, and then distributing energy 108 directly to device 112 from space. The reflector unit may comprise a reflecting dish instead of, e.g., microwave receiving and transmitting antennas and a microwave generator, and may have any suitable shape, such as, e.g., parabolic, and pattern, such as, e.g., mesh. When more than one network is employed, each network may contain a single satellite, or more.

In addition, or alternatively, the second network may comprise airborne vehicles, such as, e.g., drones, balloons, and/or aircrafts, that include the same mechanisms or systems for collecting and transmitting energy 108 as a satellite 102 of the second network would be configured to collect and transmit energy 108. In addition, or alternatively, the airborne vehicles may comprise reflector units for reflecting energy 108 from the first satellite network directly to user electronic devices from space or within the atmosphere. In some cases, one or both networks of satellite 102 may be disposed in a planetary orbit about Sun 104, instead of, or in addition to, Earth 114. The orbit may be circular, elliptical, or ascending/descending. If, on the other hand, it is not necessary to provide a continuous supply of electric power, then a single satellite 102 may be used, taking power at will or whenever it is positioned in solar energy receiving relationship with Sun 104. Thus by transmitting solar energy to Earth 114 in the form of transmissive energy 108, e.g., microwave, RF and/or laser energy, the effects of atmosphere, clouds and other physical influences may be essentially discounted. With a system and method that is designed to continuously receive solar energy, the amount of standby equipment and reliance on batteries may be eliminated or minimized. Finally, the use of solar energy does not deplete Earth 114's resources and presents no problems of pollution or waste removal.

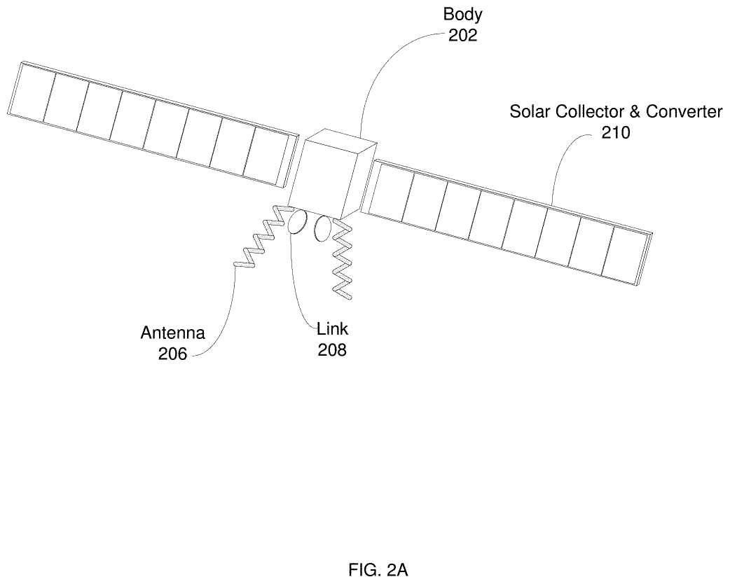

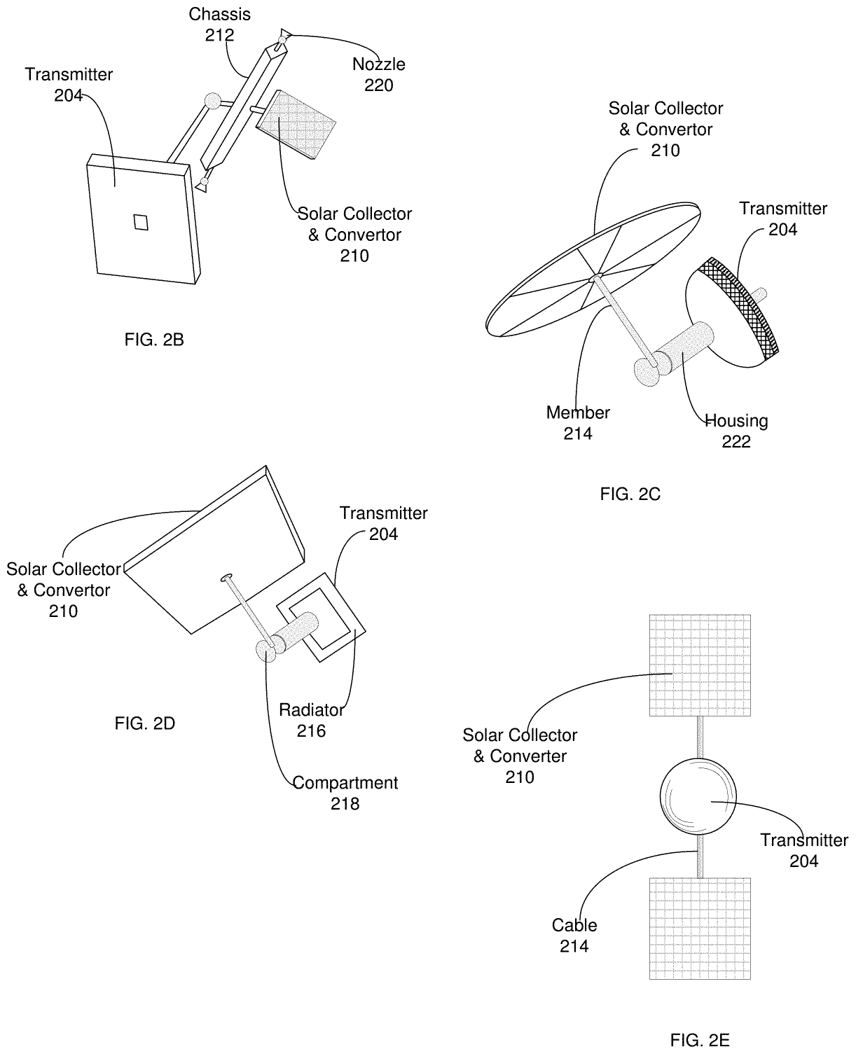

FIGS. 2A-E illustrate alternative configurations of example satellites that may be implemented in the present system and method. Any other configurations may be used. The satellite may be a member of a network or constellation of other satellites that may be configured to provide continuous coverage to predetermined areas on Earth, and may comprise a central body 202. Body 202 may house a service module and/or a communications payload. The communications payload may comprise a space to ground antenna 206 and inter-satellite link 208. Antenna 206 may comprise any configuration, such as, e.g., helical, spherical, dipole and patch. The device may comprise a plurality of antenna 206 such that new connections can be established before the old one is broken, as the satellite constellation passes the device. In some cases, the satellite may be configured to communicate by optical data transmission using the satellite's one or more transceivers.

The service module may comprise a structural subsystem configured to provide a mechanical base structure and to shield internal circuitry from extreme temperature changes, the ambient environment, radiation effect and/or micrometeorite damage; a telemetry subsystem configured to monitor onboard equipment operations, transmits equipment operation data to an earth control station, and/or receive the control station's commands to perform equipment operation adjustments; a solar collector and converter 210, such as, e.g., an optical rectenna or nantenna, a microwave or RF rectenna, a photovoltaic or solar cell, and/or a thermoelectric or thermionic device, for harvesting solar radiation energy and converting it to electrical energy, and then further converting the electrical energy to a transmissive energy, such as, e.g., microwave, RF and/or laser energy, for beaming directly to electronic devices located on Earth; a thermal control subsystem configured to protect electronic equipment from extreme temperatures due to internally produced heat, external solar heat, and the freezing temperatures due to lack of sunlight exposure on different sides of central body 202; and an attitude and orbit control subsystem comprising attitude and orbit control sensors and actuators, e.g., propulsion mechanisms such as small rocket thrusters, configured to maintain the satellite in a predetermined orbital orientation and position, in addition to maintaining direction of the one or more antenna 206.

In FIG. 2B the satellite may comprise a chassis 212 coupled to solar collector & converter 210, such as, e.g., an optical rectenna, a microwave or RF rectenna, a photovoltaic or solar cell, and/or a thermoelectric or thermionic device, for harvesting solar radiation energy and converting it to electrical energy. The electrical energy is, in turn, converted to a transmissive energy, such as, e.g., microwave, RF and/or laser energy, and then beamed directly to one or more user electronic devices located on Earth from space by transmitter 204 without going through a terrestrial distribution center, such as, e.g., a base station. Propulsion devices or stabilizers comprising rocket nozzle 220 may be coupled to chassis 212 for stabilizing or maintaining the satellite in orbit and at a predetermined orientation and distance. FIG. 2C is a satellite comprising solar collector & converter 210 pivotally mounted on support member 214, which is pivotally attached to equipment housing 222. Solar collector & converter 210 may comprise a large surface area platform and a disc or dish shape. Any other shape may be used, such as, e.g., rectangle, triangle, or any other polygon. The solar collector & converter 210 may be divided into a plurality of sectors associated with solar radiation collecting, converting, and transmitting means that may be coupled to a transmissive energy generator, such as, e.g., microwave, RF and/or laser energy, located in housing 222. Small altitude control rockets may be provided to position solar collector & converter 210 in a continuously optimum orientation. Transmitter 204, such as, e.g., a transmitting antenna, may be affixed to housing 222 with appropriate guidance and attitude control means for directing beams of transmissive energy to user electronic devices. FIG. 2D is a satellite similar to that of FIG. 2C; however, solar collector & converter 210 and transmitter 204 may be configured into a planar shape, such as, e.g., a rectangle. Transmitter 204 may be a planar phased array that includes waste heat radiator 216. Suitable cooling equipment may be housed in compartment 218 configured to supply refrigeration to the satellite, including transmitter 204. FIG. 2E is a satellite comprising two arrays of solar collector & converter 210 joined through articulated cable 214 to transmitter 204, which may be of any design and configuration.

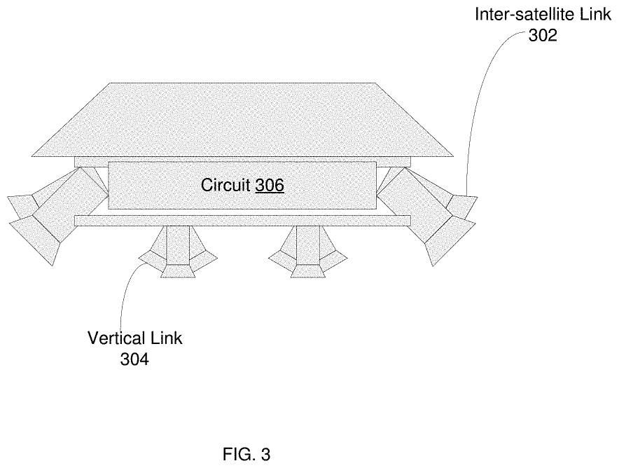

FIG. 3 illustrates a communication payload that may be implemented in the present system and method. The payload may comprise inter-satellite link 302 disposed at an exterior portion of a satellite for inter-satellite, intra- and inter-plane communications. Inter-satellite link 302 may comprise one or more transceivers for optical data transmission and reception, and/or one or more antennas for data transmission and reception. The transceivers and/or antennas may be configured to be adjustable or steerable, such as, e.g., for calibration with neighboring satellites or for establishing new communication paths such as when a new satellite is launched into orbit. In some cases, one or more neighboring satellites may be utilized for inter-satellite, intra- and inter-plane communications. Beam steering may be used to compensate for satellite jitter and slight orbit variations. Vertical link 304 may be configured to communicate with a control station through an uplink and/or a downlink connection, and may also be adjustable and/or steerable, such as, e.g., comprising a gimbal or electronically steered phased array. Vertical link 304 may also comprise one or more transceivers for optical data transmission and reception, and/or one or more antennas for data transmission and reception, and may be disposed on the exterior of the satellite. Circuit 306 may comprise a processor and memory configured for receiving, transmitting, filtering, processing, amplifying and/or switching data signals. In other cases, inter-satellite link 302 and vertical link 304 may not be adjustable or steerable, such that they are fixed in position.

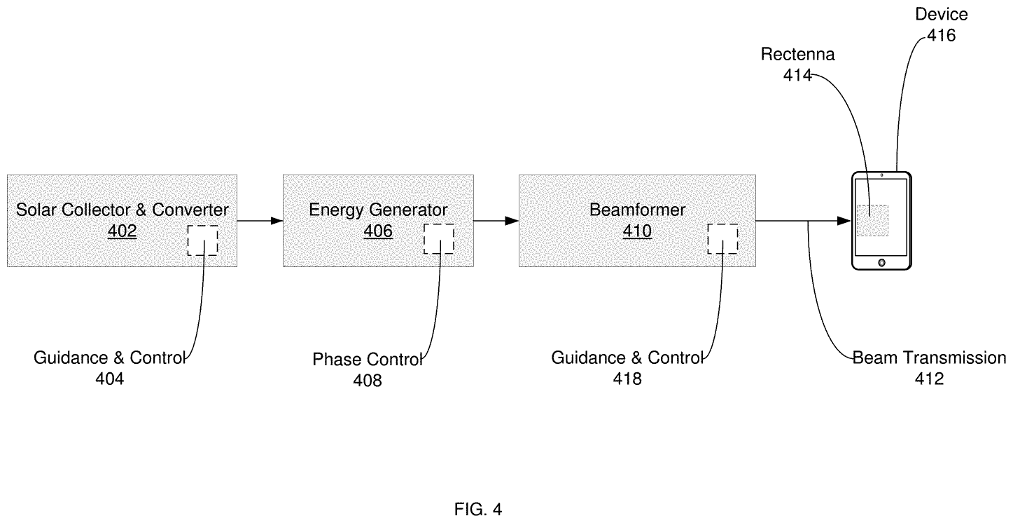

FIG. 4 is a box diagram of an example solar energy collection, conversion, transmission, and reception system. A satellite may comprise solar collector & converter 402, energy generator 406, and beamformer 410. Solar collector & converter 402 may be any mechanism for harvesting electromagnetic radiation energy from the sun and converting to electrical energy. Examples of solar collector & converter 402 include an optical rectenna, a microwave or RF rectenna, a photovoltaic or solar cell, and a thermoelectric or thermionic device. Since solar collector & converter 402 is most efficient when continually oriented to face the sun, guidance & control 404 may be provided to control its orientation. Guidance means include, e.g., sun sensors, star trackers, and horizon seekers. Control and actual orientation of solar collector & converter 402 may be facilitated by gas fired rockets or ion reaction engines.

Transmission lines may couple solar collector & converter 402 with energy generator 406, which is configured to convert the electric power developed in solar collector & converter 402 to a transmissive energy, e.g., microwave, RF and/or laser energy, so that it may be formed into a suitably shaped electromagnetic beam for transmission directly to electronic devices located on Earth from the satellite in space. Examples of energy generator 406 include, e.g., a laser, a klystron, a gyrotron, a traveling-wave tube, a twystron, backward-wave oscillators and amplifiers, and crossed-field devices which include resonant types, such as, e.g., a magnetron, and nonresonant backward and forward wave types, such as, e.g., an amplitron, carcinatron and dematron. A plurality of energy generator 406 may be employed to produce a predetermined amount of power, and may operate in phase synchronization with each other through phase control 408. This may be accomplished by the use of a controlled phase shifting network comprising phase shifters, such as, e.g., those incorporating ferrites, switched diodes, and variable-length line design techniques. Phase control 408 may operate in conjunction with a computing device, such as, e.g., a processor coupled to a memory for executing software programs. Beamformer 410 may comprise an electromagnetic radiation transmitter, such as, e.g., a phased array antenna. The phased array antenna may comprise a number of radiating elements in which the relative phases of the respective signals feeding the radiating elements are varied in such a way that the effective radiation pattern of the array is reinforced in a desired direction and suppressed in undesired directions. The radiation pattern of the beam may be formed into a desirable configuration with respect to the main beam shape and width, and to sidelobe energy distributions locked onto a receiving antenna of rectenna 414. These beam requirements may be met by generating the proper amplitude and phase source distributions over the transmitting antenna aperture, and by the use of additional mechanical or electronic beam steering and alignment mechanisms where necessary. Guidance & control 418 of beamformer 410 may be adapted to achieve alignment of antennas to aim the total array—or in effect the center of the transmitted microwave energy beam—toward the center of the receiving antenna of rectenna 414, and to effect the necessary phasing of energy generator 406. In the alignment of the panels of the array, it may first be necessary to establish a reference plane, which may be defined by the axis of a rotating laser. Antenna guidance may be accomplished by, e.g., gas-fired rockets and/or ion engines.

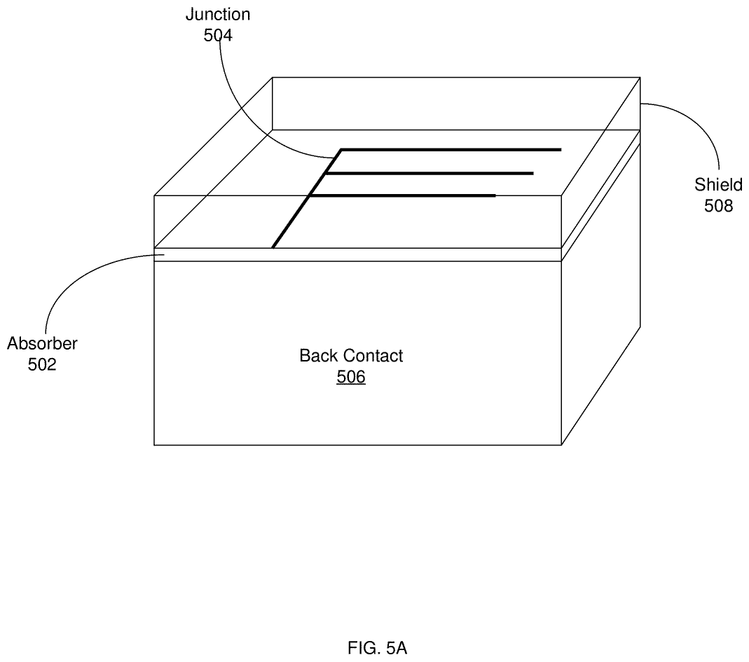

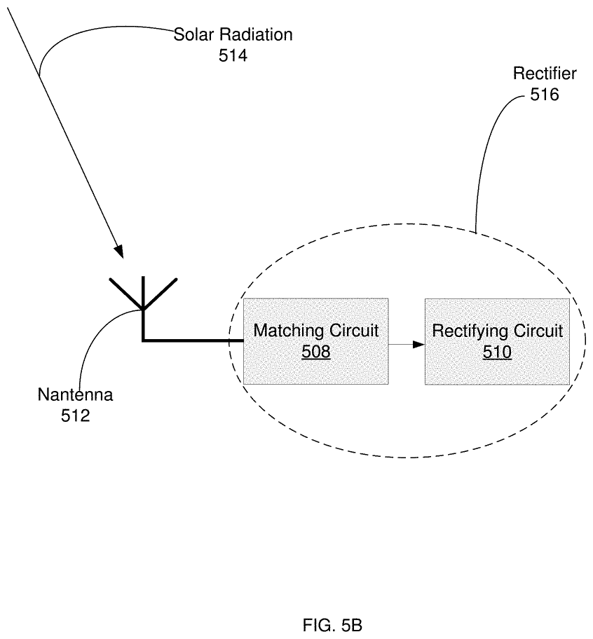

FIGS. 5A-B are example solar radiation energy collectors and converters that may be implemented in the present system and method. In FIG. 5A, a multi-layer photovoltaic cell of a solar panel may comprise an absorber 502 having one or more junctions 504 disposed between a back contact 506 on a back side and a top radiation shield 508 disposed on the surface in the direction of the incident solar radiation. The cell may include any electrical device that converts the energy of light directly into electricity by the photovoltaic effect, including, e.g., elements made from polysilicon and monocrystalline silicon, thin film solar cells that include amorphous silicon, CdTe and CIGS cells, multijunction cells, perovskite cells, organic/polymer cells, and various alternatives thereof. Radiation shield 508 may include a solar radiation transparent material such as SiO₂, among others. The back contact 506 may be made of any suitable conductive material, such as, e.g., a conductive material like aluminum, among others. Back contact 506 and top radiation shield 508 may be of any thickness suitable to provide radiation shielding to the photovoltaic cell. Additional structures may be provided to increase the efficiency of the absorption and operation of the device including, for example, one or more concentrators that gather and focus incoming solar radiation onto the cell, such as, e.g., a Cassegrain reflector. The photovoltaic cell may also incorporate a temperature management device, such as, e.g., a radiative heat sink.

FIG. 5B illustrates a box diagram showing components of an optical rectenna. An optical rectenna is a rectifying antenna that works with the THz or optical ranges of the electromagnetic spectrum, such as, e.g., ultraviolet, visible and/or infrared radiations, turning it into electricity. Although design principles of an optical rectenna is similar to that of a microwave or RF rectenna, an optical antenna or nantenna of the optical rectenna is downscaled in physical dimensions, such as, e.g., in the nanometer or micrometer ranges.

An optical rectenna may be fixated to a solar energy harvesting satellite, and may comprise nantenna 512 coupled with rectifier 516. Any type of rectenna may be used, such as, e.g., dual frequency band, multiband, broadband, narrowband, wideband, multisource, and coplanar waveguide. Rectifier 516 may be configured in the unit ranges of millimeters, micrometers, or nanometers, such as, e.g., 0.01 nm to 50 mm. Solar radiation 514 may be in the form of an electromagnetic radiation, such as, e.g., ultraviolet, visible and/or infrared radiations, emitted from the sun. Receiving nantenna 512 collects solar radiation 514 from the sun and converts the electromagnetic energy to electrical energy, e.g., alternating current, by resonating at predetermined frequency bands. The electrical energy is then passed to rectifier 516, which comprises matching circuit 508 and rectifying circuit 510, coupled to a microwave, RF and/or laser energy generator. In some cases, nantenna 512 may be connected to a filter comprising one or more capacitors connected to one or more inductors. The filter acts as a harmonic rejection device cancelling unwanted waves and stopping the signals' re-radiation back into free space. In general, rectifier 516 may be a nonlinear circuit formed by a rectification diode-capacitor combination. Nantenna 512 delivers alternating current to impedance matching circuit 508, which may be configured to match the impedance of receiving nantenna 512 to rectifying circuit 510, such as, e.g., nantenna 512's impedance is 50 Ohms and rectifying circuit 508's impedance is 50 Ohms. Matching circuit 508 may comprise one or more capacitors connected with one or more inductors. Exact matching provides maximum output voltage for the rectenna with minimum transmission losses.

Rectifying circuit 510 comprises one or more diodes, such as, e.g., a metal-insulator-metal (MIM) tunneling diode, configured to receive alternating current from matching circuit 508 and converts it to direct current power. In some cases, the electrical energy is not converted to direct current from the alternating current. Rectifying circuit 510 can be of any type, such as, e.g., a single-diode configuration in series or shunt format, dual-diode structure, voltage multiplier or a hybrid circuit. Once the rectification is complete, the signal may be passed through a filter to remove the fundamental frequency signal and harmonics generated by the nonlinear characteristic of the diode and smooth the output signals from any distortions. The captured electrical energy is then supplied to the microwave, RF and/or laser energy generator to produce microwave, RF and/or laser energy to be transmitted directly to user electronic devices located on Earth. In some cases, a network of a plurality of rectifier 516 may be used with one or more nantenna 512.

In some cases, a network of a plurality of optical rectennas may be employed with each satellite. For example, means for spectral splitting may passively or actively split electromagnetic radiation into different spectral bands, each of which is absorbed by one or rectennas having an operating voltage that optimizes the power conversion efficiency for that band. Spectral splitting can be accomplished by numerous means, such as, e.g., employing a variety of nantennas that are sensitive to a different electromagnetic frequency bands, or through a spectral splitting apparatus such as a prism.

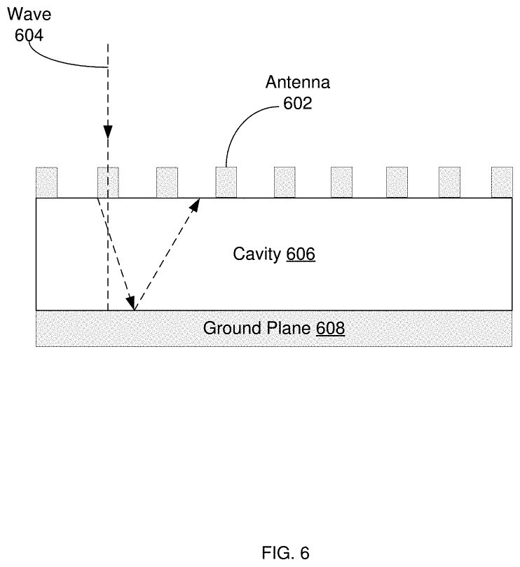

FIG. 6 illustrates main components of a nantenna of an optical rectenna. Rather than generating single electron-hole pairs as in a photovoltaic cell, incoming electromagnetic field induces a timechanging current in the nantenna. The nantenna may comprise antenna 602, which may be configured to absorb incident electromagnetic wave 604 of any frequency by varying its dimension, such as, e.g., length. In some cases, antenna 602 may be configured as frequency selective surfaces (FSS) to efficiently absorb the entire solar spectrum. For example, electromagnetic wave 604 may be in the THz range, or one of the optical windows, e.g., ultraviolet, visible and/or infrared radiations. Optical resonance cavity 606 may be configured to bend and concentrate wave 604 back towards antenna 602 via ground plane 608. Optically resonance cavity 606 may act as a transmission line that enhances resonance.

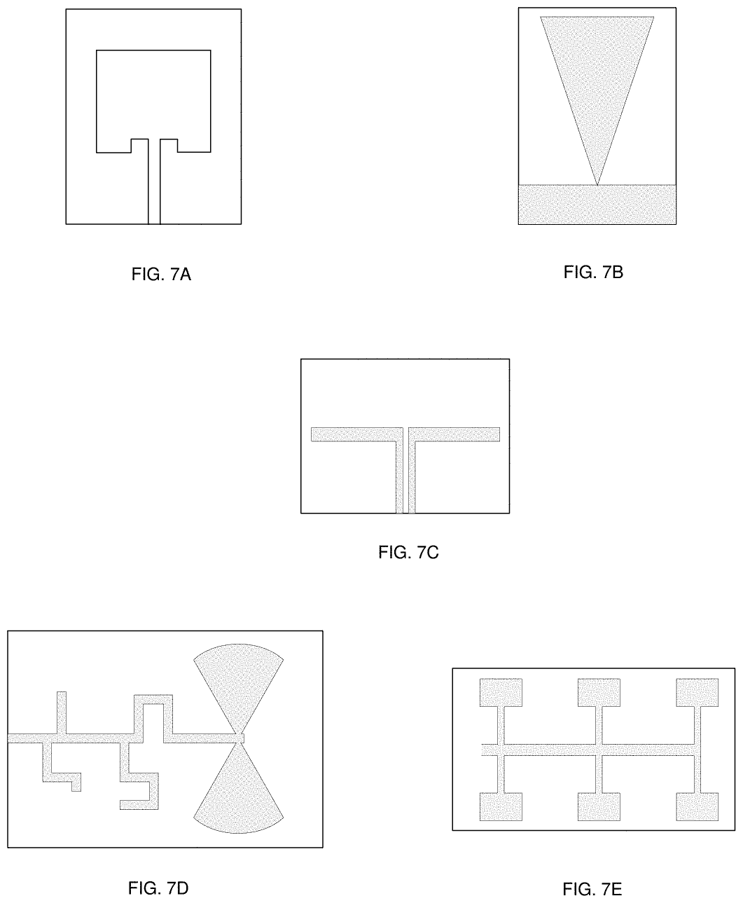

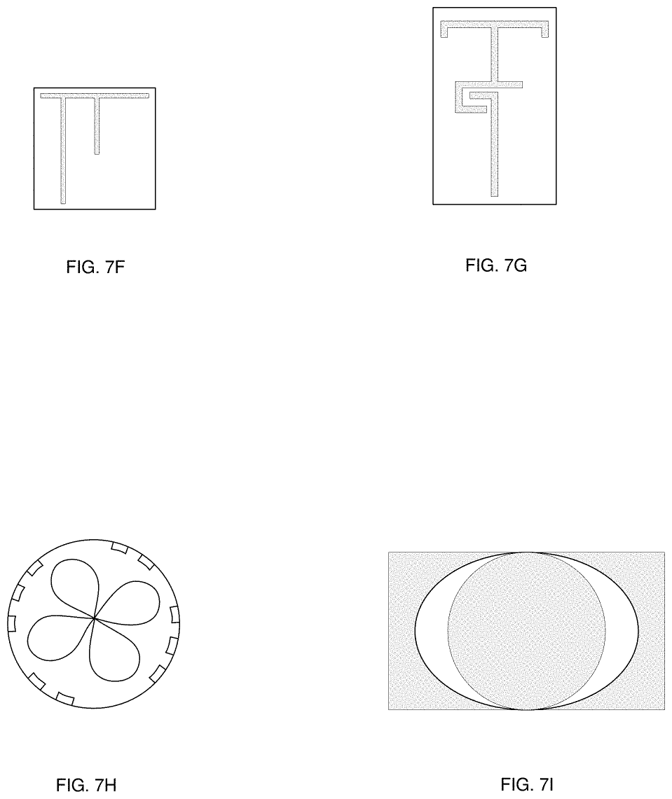

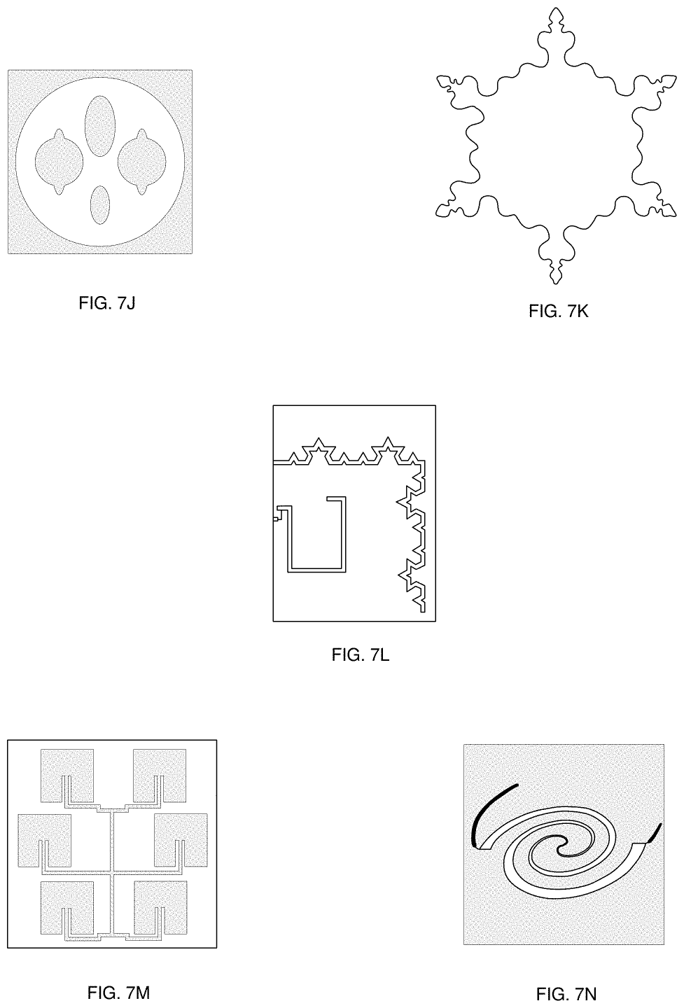

FIGS. 7A-N are example configurations of receiving antennas from an optical rectenna fixated onto a solar radiation harvesting satellite. The optical antenna is responsible for intercepting the electromagnetic waves within a specific frequency band, such as, e.g., in the THz range, or one of the optical windows, e.g., ultraviolet, visible and/or infrared radiations, and may comprise a thickness in the unit ranges of millimeters, micrometers, or nanometers, such as, e.g., 1 nm to 50 mm. In some cases, to increase energy receiving efficiency, the optical antenna may be configured in an array pattern. An antenna array, or array antenna, is a plurality of antennas proximally attached to a substrate material that functions together as a single antenna to transmit or receive energy transmission. The plurality of antennas may be combined or connected together in any combination. For example, an array may comprise of an antenna aligned perpendicular to one or more other antennas to capture polarized or collimated energy, or an antenna arranged adjacent to one or more other antennas permitting capture of unpolarized energy, such as, e.g., energy propagated in multiple dimensions and solar energy. The antenna or antennas may be manufactured from one or more materials, such as, e.g., aluminum, gold, silver, carbon, a dielectric material, doped silicon, gallium arsenide, silicon germanide, gallium nitride, molybdenum and copper. The following example configurations are to show that an antenna may take any shape, pattern, size, or form.

FIG. 7A is a microstrip patch antenna configured into a substantially rectangular shape. The rectangular shape may comprise two rectangular-shape indentations juxtapose a central transmission line connecting to a rectifier. FIG. 7B is a patch antenna having a triangular monopole design with a rectangular base. FIG. 7C is a dipole antenna comprising two horizontal arms connected to their respective vertical legs to form substantially L-shapes. FIG. 7D is a square loop antenna fed by a microstrip line with a bow-tie configuration at an end portion. FIG. 7E is a microstrip patch array comprising a plurality of substantially rectangular antennas. The antennas may be symmetrically disposed and separated by equal-lengthed microstrip transmission lines. The transmission lines may connect the antennas to a central transmission line. FIG. 7F and FIG. 7G illustrate examples of multi-band antennas designed to operate in a plurality of frequency bands, which one part of the antenna is receptive of one band, while another part is receptive of a different band. Specifically, FIG. 7F is a quadraband antenna and FIG. 7G is a hexaband antenna. FIG. 7H is a bow-tie antenna comprising four equilateral blades symmetrically arranged. FIG. 7I is an annular slot antenna comprising dual crescent-shaped cutouts on opposing sides such that together they form a circular center. FIG. 7J is a monopole antenna configured into a substantially circular shape comprising four internal cutouts. Two of the cutouts disposed on oppose sides are substantially circular comprising top and bottom protrusions. The other two cutouts are oval-shaped and differing in sizes, with the larger cutout disposed above the smaller cutout. FIG. 7K is an antenna configured into a fractal geometry. A fractal is a never-ending pattern that is self-similar across different scales, and is created by repeating a simple process over and over in an ongoing feedback loop. Any other fractal geometry may be used. FIG. 7L is a dual-band antenna comprising two frequency band arms. The longer arm is configured into a substantially L-shape comprising a second-order Koch fractal pattern. The shorter arm is configured into a plurality of straight line segments. FIG. 7M is another microstrip patch array comprising a plurality of substantially rectangular antennas. The antennas may be symmetrically disposed and separated by unequal-lengthed microstrip transmission lines. The transmission lines may connect the antennas to a central transmission line. FIG. 7N is a spiral-shaped antenna comprising two ends. The antenna's thickness may progressively increase from a center portion of the spiral towards the end portions. Any other spiral configuration may be used. FIGS. 7A-N is not meant to be a comprehensive list of all possible antenna types and configurations. For example, other structures may include, e.g., Yagi-uda, parabolic, ring, disc, half-wave dipole, and various polygonal shapes. In some cases, the addition of one or more stubs or transmission lines of various lengths and widths to an antenna's configuration may be applied to match the antenna to the rectifier and may depend on the designed frequency that is either kept open-circuit or short-circuit to a ground plane. Stub utilization may increase the amount of frequency bands that can be used for harvesting electromagnetic energy.

In some cases, the nantenna may comprise graphene, which may be a one-atom-thick, two-dimensional carbon crystal. Graphene's unique structure may permit electrons that are able to move with minimal resistance. In some cases, the nantenna may comprise a dielectric resonator (DR), which is a nonmetallized material, such as, e.g., ceramic. In some cases, the nantenna may comprise polydimethylsiloxane (PDMS), such as, e.g., in a form of a lens. In some cases, a thermopile nantenna may be utilized to capture infrared light having heat signatures to convert thermal waves into output voltage. A thermopile nantenna may be formed by a plurality of thermocouples connected either in series or parallel configuration. In some cases, the nantenna may comprise arrays of single- or multi-wall carbon nanotubes (CNT) that are coupled to a nanoscale rectifying diode.

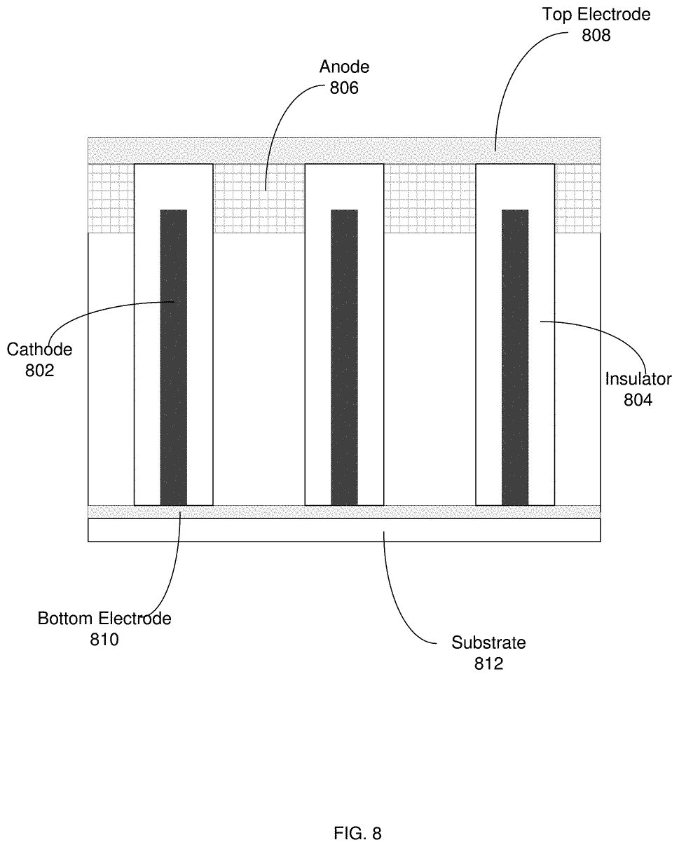

FIG. 8 illustrates a carbon nanotube rectenna. The rectenna may comprise one or more vertically aligned carbon nanotube cathode 802 operating as nano-antennas, or nantennas, to collect electromagnetic waves. Cathode 802 may be coated with insulator 804, such as, e.g., aluminum oxide, and capped with anode 806, such as, e.g., aluminum. Top electrode 808 may comprise, e.g., aluminum. Cathode 802 may be disposed on a bottom electrode 810, such as, e.g., titanium, which is in turn disposed on substrate 812, such as, e.g., silicon. The metal-insulator-metal sandwich structure permits the nanotube array to behave as both a light harvester and a tunnel diode. Electromagnetic waves collected at cathode 802 is then converted or rectified to electrical energy, e.g., direct current, by anode 804. The rectified electrical energy may be used to charge a capacitor or a load.

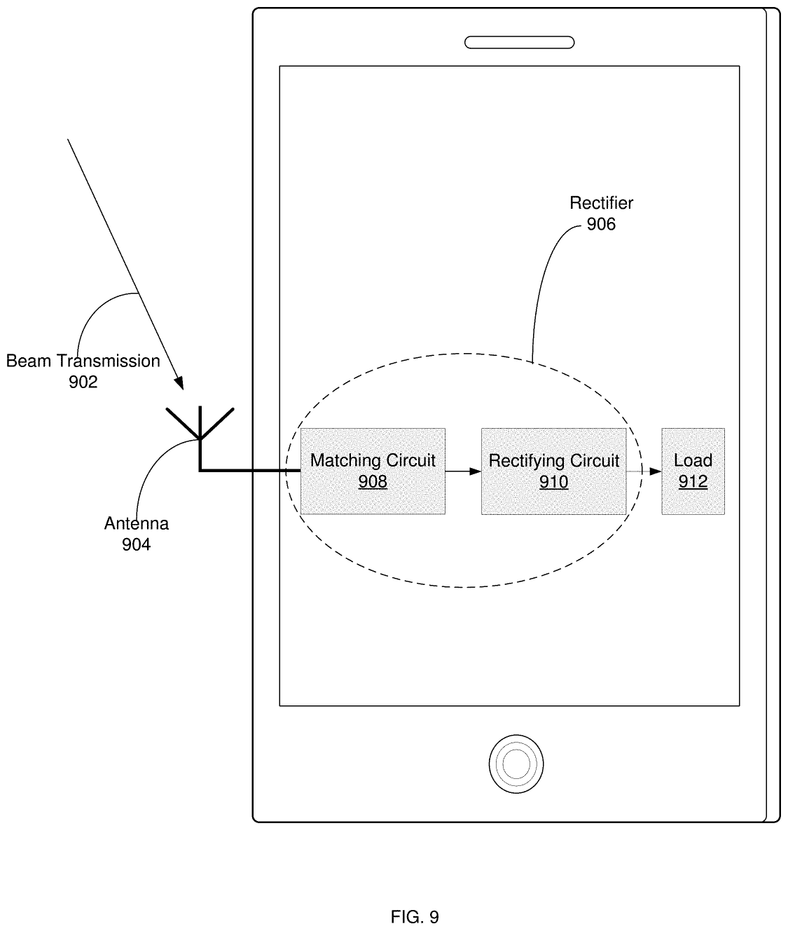

FIG. 9 is a box diagram of an example transmissive energy reception, conversion and utilization system, and is a continuation from FIG. 4. A microwave or RF rectenna may be embedded within, or otherwise integrated with, an electronic device and may comprise antenna 904 coupled with rectifier 906. Any type of rectenna may be used, such as, e.g., dual frequency band, multiband, broadband, narrowband, wideband, multisource, and coplanar waveguide. The microwave or RF rectenna may be configured in the unit ranges of millimeters, micrometers, and/or nanometers, such as, e.g., 0.01 nm to 50 mm. Beam transmission 902 may be an electromagnetic energy transmission, such as, e.g., microwave, RF and/or laser, emitted from a solar radiation harvesting satellite or an intermediary distribution satellite that has received solar radiation energy from a solar radiation harvesting satellite. Receiving antenna 904 collects beam transmission 902 and converts the electromagnetic energy to electrical energy, e.g., alternating current, by resonating at predetermined frequency bands and passes it to rectifier 906, which comprises matching circuit 908 and rectifying circuit 910, coupled to load 912. In some cases, antenna 904 may be connected to a filter comprising one or more capacitors connected to one or more inductors. The filter acts as a harmonic rejection device cancelling unwanted waves and stopping the signals' re-radiation back into free space. In general, rectifier 906 may be a nonlinear circuit formed by a rectification diode-capacitor combination. Antenna 904 delivers the electromagnetic energy from beam transmission 902 to impedance matching circuit 908, which may be used to match the impedance of receiving antenna 904 to rectifying circuit 910, such as, e.g., antenna 904's impedance is 50 Ohms and rectifying circuit 910's impedance is 50 Ohms. Matching circuit 908 may comprise one or more capacitors connected with one or more inductors. Exact matching provides maximum output voltage for the rectenna with minimum transmission losses.

Rectifying circuit 910 comprises one or more diodes, such as, e.g., a Schottky diode configured to receive alternating current from matching circuit 908 and converts it to direct current power. In some cases, the electrical energy is not converted to direct current from the alternating current. Rectifying circuit 910 can be of any type, such as, e.g., a single-diode configuration in series or shunt format, dual-diode structure, voltage multiplier or a hybrid circuit. Once the rectification is complete, the signal may be passed through a filter to remove the fundamental frequency signal and harmonics generated by the nonlinear characteristic of the diode and smooth the output signals from any distortions. The captured electrical energy is then supplied to load 912, the electronic device's component or portion of a circuit that consumes electric power, or to a reserve, such as, e.g., a battery, for operating the device. In some cases, a network of a plurality of rectifier 906 may be used with one or more antenna 904.

In some cases, a network of a plurality of microwave or RF rectennas may be employed with each electronic device. For example, means for spectral splitting may passively or actively split electromagnetic radiation into different spectral bands, each of which is absorbed by one or rectennas having an operating voltage that optimizes the power conversion efficiency for that band. Spectral splitting can be accomplished by numerous means, such as, e.g., employing a variety of antennas that are sensitive to a different electromagnetic frequency bands, or through a spectral splitting apparatus such as a prism.

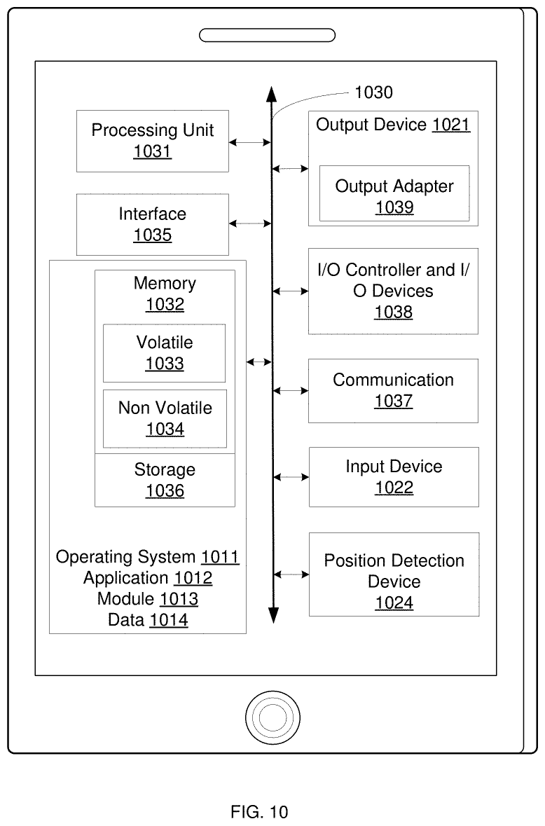

FIG. 10 illustrates other components that can be found in the example electronic device of FIG. 9. The processing unit 1031 may be any of various available processors, such as single microprocessor, dual microprocessors or other multiprocessor architectures. The system bus 430 may be any type of bus structures or architectures, such as 12-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), or Small Computer Systems Interface (SCST).

The system memory 1032 may include volatile memory 1033 and nonvolatile memory 1034. Nonvolatile memory 1034 may include read only memory (ROM), programmable ROM (PROM), electrically programmable ROM (EPROM), electrically erasable ROM (EEPROM), or flash memory. Volatile memory 1033, may include random access memory (RAM), synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), or direct Rambus RAM (DRRAM).

The device also includes storage media 1036, such as removable/non-removable, volatile/nonvolatile disk storage, magnetic disk drive, floppy disk drive, tape drive, Jaz drive, Zip drive, LS-100 drive, flash memory card, memory stick, optical disk drive such as a compact disk ROM device (CD-ROM), CD recordable drive (CD-R Drive), CD rewritable drive (CD-RW Drive) or a digital versatile disk ROM drive (DVD-ROM). A removable or non-removable interface 1035 may be used to facilitate connection.

The device may further include software to operate, such as an operating system 1011, system applications 1012, program modules 1013 and program data 1014, which are stored either in system memory 1032 or on disk storage 1036. Various operating systems or combinations of operating systems may be used.

Input device 1022 may be used to enter commands or data, and may include a pointing device such as a mouse, trackball, stylus, touch pad, keyboard, microphone, joystick, game pad, satellite dish, scanner, TV tuner card, sound card, digital camera, digital video camera, web camera, and the like, connected through interface ports 1038. Interface ports 1038 may include a serial port, a parallel port, a game port, a universal serial bus (USB), and a 1394 bus. The interface ports 1038 may also accommodate output devices 1021. For example, a USB port may be used to provide input to the mobile device and to output information from the mobile device to an output device 1021. Output adapter 1039, such as video or sound cards, is provided to connect to some output devices such as monitors, speakers, and printers.

The position detection device 424 may be a device that communicates with a plurality of positioning satellites, e.g., GPS satellites, to determine the geographical location of the mobile device, and thus the user. To determine the location of the user, the position detection device 1024 searches for and collects GPS information or signals from four or more GPS satellites that are in view of the position detection device 1024. Using the determined time interval between the broadcast time and reception time of each signal, the position detection device 1024 may calculate the distance of the user relative to each of the four or more GPS satellites. These distance measurements, along with the position and time information received in the signals, allow the position detection device 1024 to calculate the geographical location of the user.

Example configurations of receiving antennas from a microwave or RF rectenna embedded within an electrical device can be found in FIGS. 7A-N, which mirrors the configurations of receiving nantennas of an optical rectenna. The microwave or RF rectenna's antenna is responsible for intercepting the electromagnetic waves within a specific frequency band, such as, e.g., microwave or RF, and may comprise a thickness in the micrometer or millimeter unit range, such as, e.g., 1 μm to 100 mm. In some cases, to increase energy receiving efficiency, the microwave or RF antenna may be configured in an array pattern. An antenna array, or array antenna, is a plurality of connected antennas, which work together as a single antenna, to transmit or receive energy transmission. The example configurations are to show that the antenna may take any shape, pattern, size, or form. Two or more antennas may be combined or connected together in any combination.

FIG. 11 is a flowchart of a method for solar energy harvesting, conversion and direct transmission to an electronic device. Operation 1102 collects and converts solar radiation energy to electrical energy by one or more satellites orbiting the earth and/or sun. Solar energy collection and conversion may include one or more optical rectennas, microwave or RF rectennas, photovoltaic or solar cells, and/or thermoelectric or thermionic devices located on the satellites. For example, a receiving a nantenna of an optical rectenna collects solar radiation from the sun and converts the electromagnetic energy to electrical energy by resonating at predetermined frequency bands. Any type of rectenna may be used, such as, e.g., dual frequency band, multiband, broadband, narrowband, wideband, multisource, and coplanar waveguide. In some cases, a matching circuit of the rectenna matches an antenna's impedance with a rectifying circuit's impedance prior to rectifying the electromagnetic energy to electrical energy. Operation 1104 generates a transmissive energy from the electrical energy for transmission directly to electronic devices located on Earth. Examples of a transmissive energy includes, e.g., microwave, RF and laser energy. Examples of an energy generator used to generate the transmissive energy include, e.g., a laser, a klystron, a gyrotron, a traveling-wave tube, a twystron, backward-wave oscillators and amplifiers, and crossed-field devices which include resonant types, such as, e.g., a magnetron, and nonresonant backward and forward wave types, such as, e.g., an amplitron, carcinatron and dematron. A plurality of energy generators may be employed to produce a predetermined amount of power, and may operate in phase synchronization with each other. This may be accomplished by the use of a controlled phase shifting network comprising phase shifters, such as, e.g., those incorporating ferrites, switched diodes, and variable-length line design techniques.

Operation 1106 forms a transmissive energy beam by an electromagnetic radiation transmitter, such as, e.g., a phased array antenna. The phased array antenna may comprise a number of radiating elements in which the relative phases of the respective signals feeding the radiating elements are varied in such a way that the effective radiation pattern of the array is reinforced in a desired direction and suppressed in undesired directions. The radiation pattern of the beam may be formed into a desirable configuration with respect to the main beam shape and width, and to sidelobe energy distributions locked onto a receiving antenna of a rectenna. These beam requirements may be met by generating the proper amplitude and phase source distributions over the transmitting antenna aperture, and by the use of additional mechanical or electronic beam steering and alignment mechanisms where necessary. Alignment of antennas may be achieved to aim the total array—or in effect the center of the transmitted microwave energy beam—toward the center of the receiving antenna of the rectenna, and to effect the necessary phasing of the energy generator. In the alignment of the panels of the array, it may first be necessary to establish a reference plane, which may be defined by the axis of a rotating laser. Antenna guidance may be accomplished by, e.g., gas-fired rockets and/or ion engines. Operation 1108 transmits the energy beam directly to the electronic device from the satellites located in space.

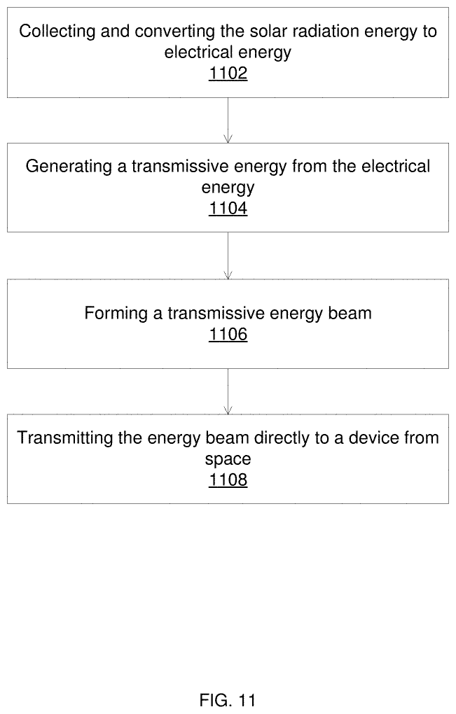

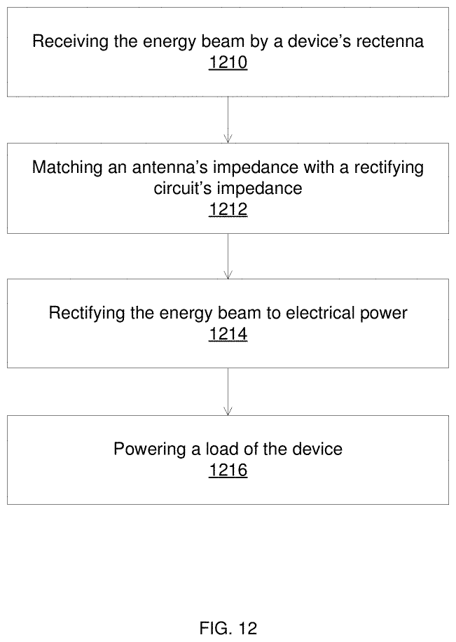

FIG. 12 is a flowchart of a method for transmissive energy reception, conversion and utilization. Operation 1210 receives an energy beam transmitted from space by an antenna of an electronic device's rectenna. A rectenna may be embedded within, or otherwise integrated with, the electronic device and may comprise an antenna coupled with a rectifier. For example, the rectenna may be integrated on the covering or “skin” of the device. Any type of rectenna may be used, such as, e.g., dual frequency band, multiband, broadband, narrowband, wideband, multisource, and coplanar waveguide. Operation 1212 matches an antenna's impedance with a rectifying circuit's impedance. For example, the antenna's impedance is 50 Ohms and rectifying circuit's impedance is 50 Ohms. Operation 1214 rectifies the energy beam to electrical power. Operation 1216 powers a load the the electronic device, such as, e.g., to operate the device and/or to charge an energy reserve, e.g., a battery.

The concept behind optical rectennas is essentially the same as for traditional microwave or RF rectennas. Incident light on the antenna causes electrons in the antenna to move back and forth at the same frequency as the incoming light. This is caused by the oscillating electric field of the incoming electromagnetic wave. The movement of electrons is an alternating current in the antenna circuit. To convert this to direct current, the alternating current must be rectified, which is typically accomplished with a diode. The resulting direct current can then be used to power an external load.

Antennas tend to be a similar size to the wavelength at which they operate, so a very tiny optical antenna or nantenna requires a challenging nanotechnology fabrication process. Because of limitations in nanotechnology fabrication, it has previously not been possible to develop, at a large-scale, rectennas that can operate in the THz or or optical ranges of the electromagnetic spectrum, such as, e.g., ultraviolet, visible and/or infrared radiations. Current nantennas are produced using electron beam lithography, which may be slow and relatively expensive because parallel processing is not possible.

An improved system and a method to manufacture optical antennas or nantennas at a nano-scale using additive manufacturing, e.g., 3D Printing, where ink or aerosol jets deposit material such as, e.g., aluminum, gold, silver, carbon, a dielectric material, doped silicon, gallium arsenide, silicon germanide, gallium nitride, molybdenum and copper, is disclosed. The aforementioned materials can be sintered at high temperatures, and therefore are amenable to integrated manufacture. Compared with traditional methods, this process may be inherently precise and repeatable, has much higher geometric and spatial resolutions, and produces higher density components with less material waste. In addition, a key advantage for purposes of this invention is that more complex shapes that were not possible before can now be printed, which can be used to improve specification and/or structural integrity of the product.

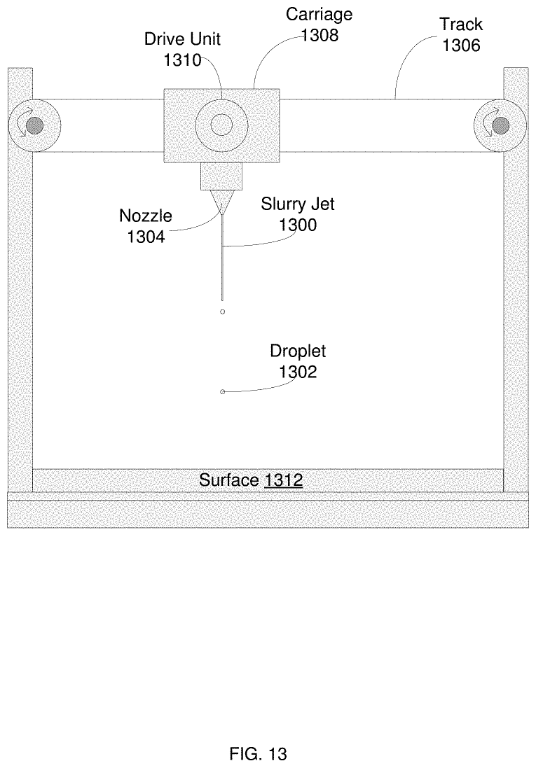

FIG. 13 is a system of a drop-on-demand type additive printer that may be used to implement one or more embodiments of the present invention. A slurry jet 1300 may be dispensed from a nozzle 1304 having an orifice comprising an opening, and may be raster or vector scanned on track 1306 by a carriage 1308 driven by drive unit 1310 over a surface 1312 or on top of an already formed powder bed to define a new layer. Pressure may be used to force the slurry out of the nozzle and into a continuous stream of slurry jet 1300 and/or as droplet 1302, which may be defined as a breakup of the flow. A layer surface height measurement unit, such as, e.g., a laser rangefinder may be used to receive an input signal to control the height of the surface that is formed by varying the delivery of slurry.

A typical implementation of an additive manufacturing process begins with defining a three-dimensional geometry of the product using computer-aided design (CAD) software. This CAD data is then processed with software that slices the model into a plurality of thin layers, which are essentially two-dimensional. A physical part is then created by the successive printing of these layers to recreate the desired geometry. This process is repeated until all the layers have been printed. Typically, the resulting part is a “green” part, which may be an unfinished product that can undergo further processing, e.g., sintering. The green part may be dense and substantially non-porous.

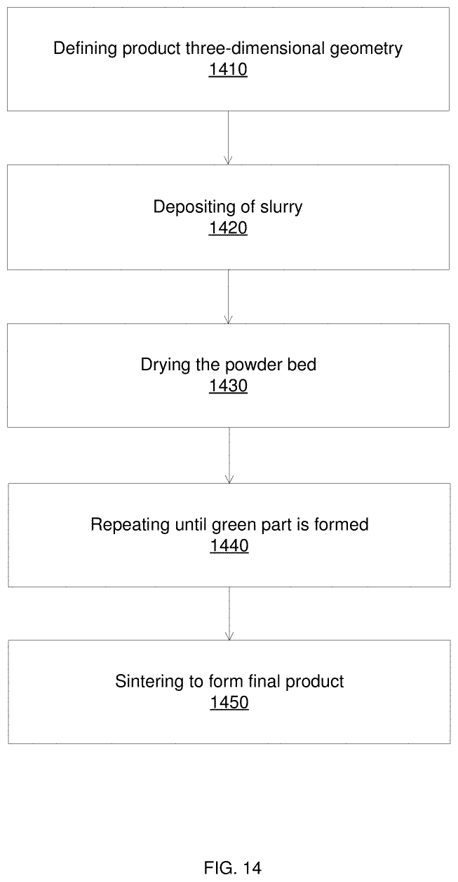

FIG. 14 is a flow diagram of a method of an additive printing process that may be implemented with one or more embodiments of the present invention. Operation 1410 defines a final product's three-dimensional geometry using CAD software. Operation 1420 deposits layers of slurry comprising powder material and binder onto a surface or on top of a powder bed, which then slip-casts to make a new layer. As the slurry deposits in each two dimensional layer, the printer may select the material type, in separate passes or as a combined pass. The slurry may be deposited in any suitable manner, including depositing in separate, distinct lines, e.g., raster or vector scanning, by a plurality of simultaneous jets that coalesce before the liquid slip-casts into the bed, or by individual drops. The deposit of slurry drops may be individually controlled, thereby generating a regular surface for each layer. Operation 1430 dries any liquid from the powder bed, e.g., infrared flash-dry, after deposition of each layer. Operation 1440 repeats operations 1410 to 1440 until a green part is formed. Operation 1450 sinters the green part to form a final product. Sintering is a solid-state diffusion process that may be enhanced by increasing the surface area to volume ratio of the powder in any green part that is subsequently sintered.

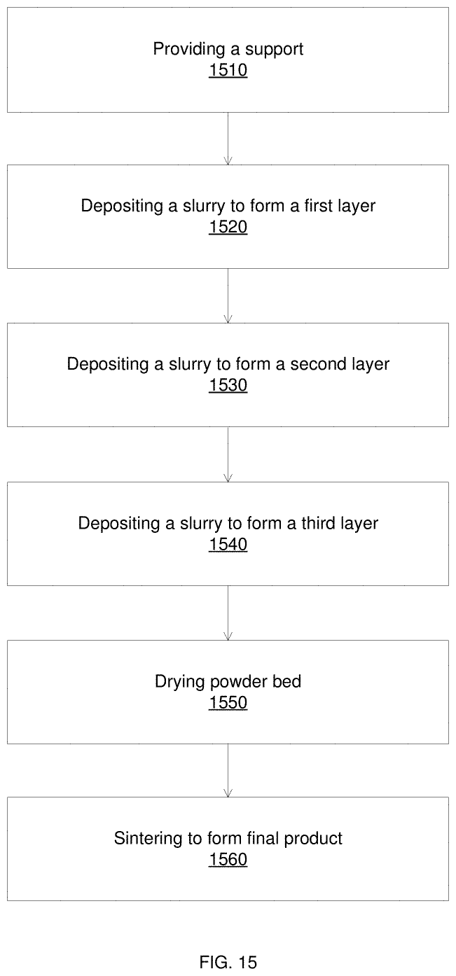

FIG. 15 is a flow diagram of a method for additive manufacturing an optical antenna or nantenna. Operation 1510 provides a support over a selected area. Operation 1520 deposits liquid slurry that contains a slurry to form a first layer, such as, e.g., a ground plane. The slurry may be deposited as continuous parallel streams, or as individually controlled droplets, thereby generating a regular surface for each layer. Operation 1530 deposits liquid slurry to form a second layer, such as, e.g., an optical resonance cavity. Operation 1540 deposits liquid slurry to form a third layer, such as, e.g., an antenna. Operation 1550 dries the powder bed by flash drying, e.g., infrared heating. Operation 1560 sinters the powder bed to form a final product.

A number of examples have been described. Nevertheless, it will be understood that various modifications may be made without departing from the spirit and scope of the claimed invention. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other examples are within the scope of the following claims.

It may be appreciated that the various systems, methods, and apparatus disclosed herein may be configured in a machine-readable medium and/or a machine accessible medium, and/or may be performed in any order. The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A method, comprising:
collecting and converting solar radiation energy to electrical energy by at least one satellite;
generating a transmissive energy from the electrical energy;
forming a transmissive energy beam; and
transmitting the energy beam from space directly to an electronic device located on Earth.

2. The method of claim 1, further comprising:
receiving the energy beam by the electronic device's rectenna.

3. The method of claim 2, further comprising:
converting the energy beam to alternating current.

4. The method of claim 2, further comprising:
wherein the rectenna is integrated with the electronic device.

5. The method of claim 3, further comprising:
matching the rectenna's antenna impedance with the rectenna's rectifying circuit impedance.

6. The method of claim 5, further comprising:
rectifying the alternating current to direct current.

7. The method of claim 6, further comprising:
powering a load of the electronic device.

8. A method, comprising:
collecting and converting solar radiation energy to electrical energy by at least one satellite;
generating a transmissive energy from the electrical energy;
forming a transmissive energy beam;
transmitting the energy beam from space directly to an electronic device located on Earth;
receiving the energy beam by the electronic device's rectenna;
converting the energy beam to alternating current;
matching the rectenna's antenna impedance with the rectenna's rectifying circuit impedance;
rectifying the alternating current to direct current; and
powering a load of the electronic device.

9. A method of claim 8, further comprising:
wherein the transmissive energy comprises microwave energy, radiofrequency energy, laser energy, or any combination thereof.

10. A method of claim 8, further comprising:
wherein the at least one satellite comprises a solar radiation collection and converting means.

11. A method of claim 10, further comprising:
wherein the solar radiation collection and conversion means comprises an optical rectenna configured to collect and convert electromagnetic radiation in the terahertz range, optical range, or both ranges.

12. A method of claim 11, further comprising:
wherein the optical rectenna comprises a nantenna and a rectifier.

13. A method of claim 12, further comprising:
wherein the nantenna is configured to receive solar radiation and convert it to alternating current.

14. A method of claim 12, further comprising:
wherein the nantenna is manufactured by an additive manufacturing process.

15. A method of claim 12, further comprising:
wherein the nantenna comprises a ground plane, an optical resonance cavity, and an antenna.

16. A method of claim 12, further comprising:
wherein the nantenna comprises a carbon nanotube, graphene, a metal, or any combination thereof.

17. A method of claim 12, further comprising:
wherein the rectifier comprises a matching circuit and a rectifying circuit.

18. A method of claim 17, further comprising:
wherein the matching circuit is configured to match the nantenna's impedance with the optical rectenna rectifying circuit's impedance.

19. A method of claim 17, further comprising:
wherein the rectifying circuit is configured to rectify the alternating current to direct current.

20. A method, comprising:
collecting and converting solar radiation energy to electrical energy by at least one satellite;
generating a transmissive energy from the electrical energy;
forming a transmissive energy beam;
transmitting the energy beam from space directly to an electronic device located on Earth;
receiving the energy beam by the electronic device's rectenna;
converting the energy beam to alternating current,
wherein the rectenna is integrated with the electronic device;
matching the rectenna's antenna impedance with the rectenna's rectifying circuit impedance;
rectifying the alternating current to direct current;
powering a load of the electronic device,
wherein the transmissive energy comprises microwave energy, radiofrequency energy, laser energy, or any combination thereof,
wherein the at least one satellite comprises a solar radiation collection and converting means,
wherein the solar radiation collection and conversion means comprises a photovoltaic cell or an optical rectenna configured to collect and convert electromagnetic radiation in the terahertz range, optical range, or both ranges,
wherein the optical rectenna comprises a nantenna and a rectifier,
wherein the nantenna is configured to receive solar radiation and convert it to alternating current,
wherein the nantenna is manufactured by an additive manufacturing process,
wherein the nantenna comprises a carbon nanotube, graphene, a metal, or any combination thereof,
wherein the rectifier comprises a matching circuit and a rectifying circuit,
wherein the matching circuit is configured to match the nantenna's impedance with the optical rectenna rectifying circuit's impedance, and
wherein the rectifying circuit is configured to rectify the alternating current to direct current.
